(19) United States
(12) Patent Application Publication
(10) Pub. No.: US 2009/0017262 A1
(43) Pub. Date: Jan. 15, 2009

(54) TWO-LAYERED OPTICAL PLATE

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/875,958

(22) Filed: Oct. 22, 2007

(30) Foreign Application Priority Data
Jul. 12, 2007 (CN) 200710201061.4

(51) Int. Cl. B32B 3/30

(52) U.S. Cl. 428/167

(57) ABSTRACT

An exemplary optical plate (20) includes a transparent layer (21) and a light diffusion layer (22). The transparent layer includes a light input interface (211), a light output surface (212) opposite to the light input interface, and a plurality of curved, elongated V-shaped protrusions (213). The curved, elongated V-shaped protrusions protrude out from the light output surface (212). The light diffusion layer (22) is integrally combined and tightly contacted with the light input interface (211) of the transparent layer (21), and being free of air or gas pockets trapped in an interface therebetween. The light diffusion layer (22) includes a transparent matrix resins (221) and a plurality of diffusion particles (223) dispersed in the transparent matrix resins (221).

### CROSS-REFERENCE TO RELATED APPLICATIONS

This application is related to one co-pending U.S. patent application Ser. No. [to be determined] (Attorney Docket No. US15187), entitled “TWO-LAYERED OPTICAL PLATE”, by Shao-Han Chang. Such applications have the same assignee as the instant application and are concurrently filed herewith. The disclosure of the above-identified applications is incorporated herein by reference.

### BACKGROUND OF THE INVENTION

1. Field of the Invention

The present invention generally relates to optical plates, and particularly to an optical plate for use in, for example, a liquid crystal display (LCD).

2. Discussion of the Related Art

The weight and thinness of LCD panels make them suitable for a wide variety of uses in electronic devices such as personal digital assistants (PDAs), mobile phones, portable personal computers, and other electronic devices. Liquid crystal is a substance that does not itself radiate light. Instead, the liquid crystal relies on light received from a light source in order for the liquid crystal to display images and data. In the case of a typical liquid crystal display device, a backlight module powered by electricity supplies the needed light.

FIG. 5 is an exploded, side cross-sectional view of a typical backlight module 10 employing a typical optical diffusion plate. The backlight module 10 includes a housing 11, a plurality of lamps 12 disposed on a base of the housing 11, a light diffusion plate 13 and a prism sheet 14. The light diffusion plate 13 and the prism sheet 14 are stacked on the housing 11 in that order. The lamps 12 emit light, and inside walls of the housing 11 are configured for reflecting some of the light upwards. The light diffusion plate 13 includes a plurality of embedded dispersion particles. The dispersion particles are configured for scattering received light, and thereby enhancing the uniformity of light that exits the light diffusion plate 13. The prism sheet 14 includes a plurality of V-shaped structures on a top thereof. The V-shaped structures are configured for collimating received light to a certain extent.

In use, light emitted from the lamps 12 enters the prism sheet 14 after being scattered in the diffusion plate 13. The light is refracted by the V-shaped structures of the prism sheet 14 and is thereby concentrated, so that a brightness of light illumination is increased. Finally, the light propagates into an LCD panel (not shown) disposed above the prism sheet 14. The brightness of light illumination may be improved by the V-shaped structures of the prism sheet 14, but the viewing angle may be narrow. In addition, although the diffusion plate 13 and the prism sheet 14 are in contact with each other, a plurality of air pockets still exists at the boundary therebetween. When the backlight module 10 is in use, light passes through the air pockets, and some of the light undergoes total reflection at one or another of the corresponding boundary. As a result, the light energy utilization ratio of the backlight module 10 is reduced.

Therefore, a new optical means is desired in order to overcome the above-described shortcomings. A method for making such optical means is also desired.

### SUMMARY

An optical plate according to a preferred embodiment includes a transparent layer and a light diffusion layer. The transparent layer includes a light input interface, a light output surface opposite to the light input interface, and a plurality of curved, elongated V-shaped protrusions. The curved, elongated V-shaped protrusions protrude out from the light output surface. The light diffusion layer is integrally combined and tightly contacted with the light input interface of the transparent layer, and being free of air or gas pockets trapped in an interface therebetween. The light diffusion layer includes a transparent matrix resins and a plurality of diffusion particles dispersed in the transparent matrix resins.

Other advantages and novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating principles of the present optical plate and method. Moreover, in the drawings, like reference numerals designate corresponding parts throughout several views, and all the views are schematic.

FIG. 1 is an isometric view of an optical plate in accordance with a first embodiment of the present invention.

FIG. 2 is a cross-sectional view taken along line II-II of FIG. 1.

FIG. 3 is a top plan view of the optical plate of FIG. 1.

FIG. 4 is a top plan view of an optical plate in accordance with a second embodiment of the present invention.

FIG. 5 is an exploded, side cross-sectional view of a conventional backlight module.

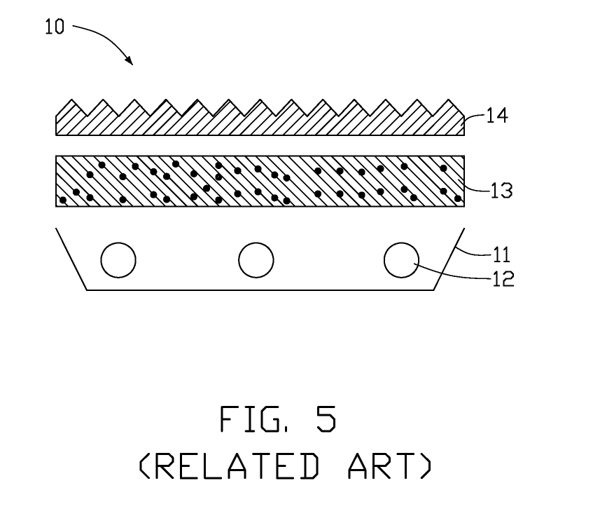

### DETAILED DESCRIPTION OF THE EMBODIMENTS

Reference will now be made to the drawings to describe preferred embodiments of the present optical plate and method for making the optical plate, in detail.

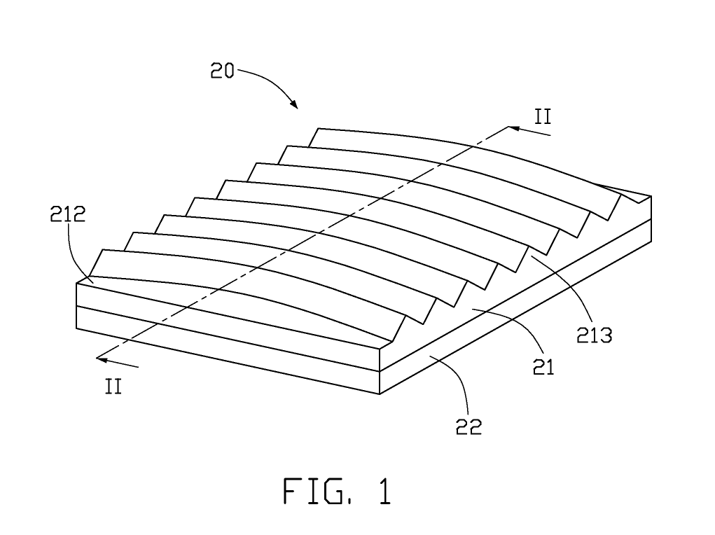

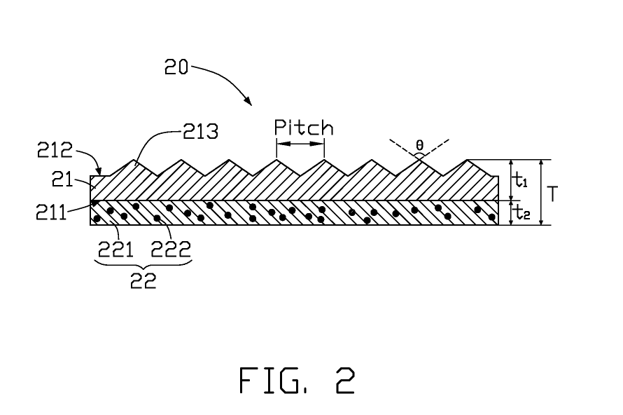

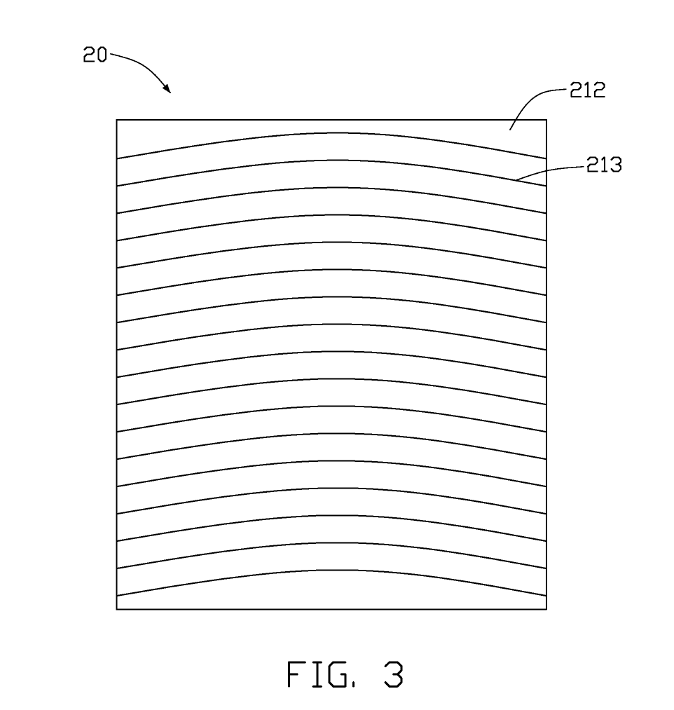

Referring to FIGS. 1 through 3, an optical plate 20 according to a first embodiment is shown. The optical plate 20 includes a transparent layer 21 and a light diffusion layer 22. The transparent layer 21 and the light diffusion layer 22 are integrally combined. That is, the transparent layer 21 and the light diffusion layer 22 are tightly contacted with each other at an interface. The transparent layer 21 includes a light input interface 211, a light output surface 212 opposite to the light input interface 211, and a plurality of curved, elongated V-shaped protrusions 213 (FIG. 3). The curved, elongated V-shaped protrusions 213 protrude out from the light output surface 212 and extend along parallel smooth curved lines of the circumference of imaginary circles. The light diffusion layer 22 is located adjacent to the light input interface 211 of the transparent layer 21. A thickness t₁ of the transparent layer 21 can equal to or greater than 0.35 millimeters, and a thickness t₂ of the light diffusion layer 22 can equal to or greater than about 0.35 millimeters. In the illustrated embodiment, a value T of the combined thickness t₁ and t₂ can be in the range from about 1 millimeter to about 6 millimeters.

The transparent layer 21 can be made of one or more transparent matrix resins selected from the group including polyacrylic acid (PAA), polycarbonate (PC), polystyrene (PS), polymethyl methacrylate (PMMA), methylmethacrylate and styrene (MS), and so on. In the illustrated embodiment, the light input interface 211 between the transparent layer 21 and the light diffusion layer 22 is flat. In an alternatively embodiment, the light input interface 211 may be configured to be rough with protrusions or slots.

The curved, elongated V-shaped protrusions 213 are configured for collimating light exiting the optical plate 20, thereby improving the brightness of light illumination. In the illustrated embodiment, the curved, elongated V-shaped protrusions 213 are arranged along parallel lines of the circumference of a plurality of imaginary arcs. The imaginary arcs have a same center, and a pitch between each two adjacent imaginary arcs is constant. The pitches between each two adjacent curved, elongated V-shaped protrusions 213 are configured to be in the range from about 0.025 millimeters to about 1 millimeter. A vertex angle θ of each curved, elongated V-shaped protrusion 213 is configured to be in the range from about 60 degrees to about 120 degrees.

The light diffusion layer 22 is configured to enhance optical uniformity. The light diffusion layer 22 includes a transparent matrix resin 221 and a plurality of diffusion particles 222 dispersed in the transparent matrix resin 221. The transparent matrix resin 221 can be one or more materials selected from the group consisting of polyacrylic acid (PAA), polycarbonate (PC), polystyrene (PS), polymethyl methacrylate (PMMA), methylmethacrylate and styrene (MS), and any suitable combination thereof. The diffusion particles 222 can be made of material selected from the group consisting of titanium dioxide, silicon dioxide, acrylic resin, and any combination thereof. The diffusion particles 222 are configured for scattering light and enhancing the light distribution capability of the light diffusion layer 22.

When the optical plate 20 is utilized in a typical backlight module, light emitted from light sources (not shown) of the backlight module enters the light diffusion layer 22 of the optical plate 20. The light is substantially diffused in the light diffusion layer 22. Subsequently, much or most of the light is condensed by the curved, elongated V-shaped protrusions 213 of the transparent layer 21 when exiting the light output surface 212. As a result, a brightness of the backlight module is increased. In addition, because the arrangement of the curved, elongated V-shaped protrusions 213 are not aligned with the LCD pixels, light or dark bands produced by diffraction between the optical plate 20 with the pixel pitch of LCD panel can be decreased or even eliminated. Furthermore, the transparent layer 21 and the light diffusion layer 22 are integrally formed together, with no air or gas pockets trapped therebetween. This increases the efficiency of utilization of light. Moreover, when the optical plate 20 is utilized in the backlight module, it can replace the conventional combination of a diffusion plate and a prism sheet. Thereby, the process of assembly of the backlight module is simplified. Moreover, the volume occupied by the optical plate 20 is generally less than that occupied by the combination of a diffusion plate and a prism sheet. Thereby, the volume of the backlight module is reduced. Still further, the single optical plate 20 instead of the combination of two optical plates/sheets can save on costs.

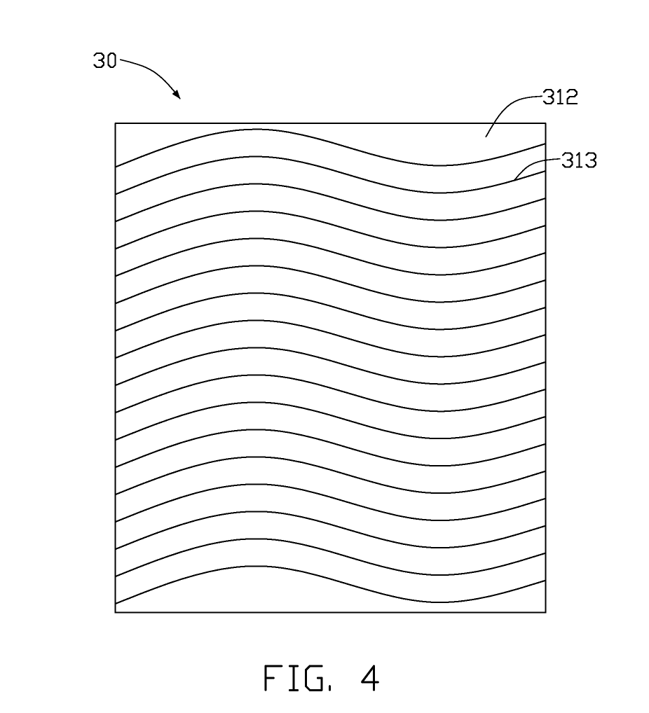

Referring to FIG. 4, an optical plate 30 in accordance with a second preferred embodiment is shown. The optical plate 30 is similar in principle to the optical plate 20 of the first embodiment, however, a plurality of curved, elongated V-shaped protrusions 313 of the optical plate 30 extend along smoothed S-shaped paths on a light output surface 312. The curved, elongated V-shaped protrusions 313 are parallel to each other.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a transparent layer including a light input interface, a light output surface opposite to the light input interface, and a plurality of curved, elongated V-shaped protrusions protruding out from the light output surface; and
a light diffusion layer integrally combined and tightly contacted with the light input interface of the transparent layer, and being free of air or gas pockets trapped in an interface therebetween, the light diffusion layer including a transparent matrix resin and a plurality of diffusion particles dispersed in the transparent matrix resin.

2. The optical plate as claimed in claim 1, wherein the curved, elongated V-shaped protrusions are arranged along parallel lines of circumference of a plurality of imaginary concentric arcs.

3. The optical plate as claimed in claim 1, wherein the curved, elongated V-shaped protrusions extend along parallel, smoothed S-shaped paths.

4. The optical plate as claimed in claim 1, wherein a pitch of adjacent two curved, elongated V-shaped protrusions is configured to be in the range from about 0.025 millimeters to about 1 millimeter.

5. The optical plate as claimed in claim 1, wherein a vertex angle of each curved, elongated V-shaped protrusion is configured to be in the range from about 60 degrees to about 120 degrees.

6. The optical plate as claimed in claim 1, wherein a thickness of the transparent layer is equal to or greater than 0.35 millimeter, and a thickness of the light diffusion layer is equal to or greater than 0.35 millimeter.

7. The optical plate as claimed in claim 1, wherein the transparent matrix resin is selected from one or more materials consisting of polyacrylic acid, polycarbonate, polystyrene, polymethyl methacrylate, methylmethacrylate and styrene, and any combination thereof.

8. The optical plate as claimed in claim 1, wherein the diffusion particles are made of one or more materials selected from the group consisting of titanium dioxide, silicon dioxide, acrylic resin, and any combination thereof.
